(19) United States
(12) Patent Application Publication
(10) Pub. No.: US 2020/0361370 A1
(43) Pub. Date: Nov. 19, 2020

(54) VEHICLE VISUAL SIGNALING DEVICE

(71) Applicant: Richard Robert WESCOTT, Limestone, ME (US)

(72) Inventor: Richard Robert WESCOTT, Limestone, ME (US)

(21) Appl. No.: 16/411,482

(22) Filed: May 14, 2019

(51) Int. Cl. B60Q 1/52; B60Q 1/26; B60Q 5/00; G01S 13/93

(52) U.S. Cl. CPC B60Q 1/525; B60Q 1/2619; G01S 2013/9392; G01S 13/931; B60Q 5/006

(57) ABSTRACT

A vehicle visual signaling device or VVSD may be provided. The VVSD may be used in conjunction with existing vehicle lighting features, and may in some exemplary embodiments transmit and receive electromagnetic radiation in the form of a radar signal. The device may emit a high intensity flashing amber or yellow light that is purposed to make the subject vehicle having the VVSD more conspicuous, assisting the subject vehicle to become more visible and helping to prevent potential accidents in high risk accident situations, such as a vehicle pulling in front of another vehicle and head-on collisions. The VVSD may utilize LEDs and radar transmitters/receivers independently housed and controlled by a microcontroller. The device may be designed for use on passenger cars, motorcycles, trucks, RVs, OHRVs, ATVs, snowmobiles and the likes thereof.

### BACKGROUND

Vehicle operators and pedestrians alike have become subject to an ever-growing number of distractions, caused by the proliferation of smartphones and other personal electronic devices, and the growing number of electronic systems built into the vehicles themselves. The National Highway Traffic Safety Administration estimates that between 400,000 and 500,000 people are injured a year, and over 30,000 people a year die by distracted driving accidents. In fact, the rate of accidents caused by distracted drivers continues to climb. The National Highway Traffic Safety Administration reports the leading distractions as talking on a cell phone while driving, sending text messages, reading, reaching for a moving object inside of the vehicle, eating and applying make-up. It is reported that 80 percent of vehicle accidents involve at least some form of driver distraction within 3 seconds of the crash.

Further distractions can be caused by inclement weather, noise, disruptive passengers, alcohol, and prescription medication. When people are driving a vehicle and are distracted, they run stop signs and traffic lights, and may miscalculate the distance between their vehicle and others. People die because someone wanted to check a text message or turn up their car stereo. People die because someone wanted to consume alcohol before getting behind the wheel, thinking that they can make it home safely. Sometimes they do, yet their victims do not.

One of the most common types of vehicle versus vehicle accidents generally, and the most common type of accident involving a motorcycle, occurs when one vehicle pulls out in front of the other, with the driver of the trailing vehicle not being able to react in time. Head-on collisions have also become increasingly common. In both cases, rates of these accidents have been exacerbated by distracted driving.

A number of states have passed legislation directed at trying to curtail distracted driving. As reported by the Governors Highway Safety Administration, 16 states, as well as D.C., Puerto Rico, Guam, and the U.S. Virgin Islands, prohibit all drivers from using hand-held cell phones while driving. 38 states and D.C. ban all cell phone use by novice drivers, and 20 states and D.C. prohibit all cell phone use for school bus drivers. Almost all states (47 states, D.C., Puerto Rico, Guam and the U.S. Virgin Islands) ban text messaging for all drivers. Of the remaining three states, two prohibit it for novice drivers, with Montana being, presently, the only state that has not seen the need for a ban of any kind. (Missouri does not restrict text messaging for drivers over the age of 21, and Arizona does not restrict it for drivers 18 and older. Further, many local ordinances are in place even in these states to further restrict cell phone usage.)

The results of these bans have not been promising. The Association for the Advancement of Automotive Medicine reports that there does not seem to have been any kind of effect on rates of texting by the passage of texting bans, though offers this with the caveat that, since cell phone use is self-reported and there are now only a very small number of control states without texting bans, the data may not be the most reliable. For example, observation surveys of drivers conducted before and after texting bans in New York (as conducted by the Institute for Traffic Safety Management and Research in 2012) and in Southern California (as reported in a personal communication to the AAAM) found that rates of texting increased after the bans. Due to the lack of effective controls, however, it is reported to be unclear whether rates were different than would have been expected without the bans. Further, drivers have self-reported that bans have had no real effect on their text messaging practices. For example, among 18-24 year-olds, 45% reported texting while driving in states with all-driver texting bans, just shy of the 48% of drivers who reported texting in states without bans. The fact that legislative enforcement has already been tried in almost all jurisdictions and does not seem to have a meaningful effect on texting rates appears to indicate that this not a problem that can be solved legislatively.

Pedestrians and cyclists, too, have become increasingly distracted. Many pedestrians text, read, make phone calls, listen to music, play video games, or otherwise make use of electronic devices while walking from place to place, even while walking in crosswalks. Cyclists more commonly make use of hands-free distractions, such as listening to music, since managing the simultaneous activities of balancing a bike, typing on a small key pad, and trying to process the quickly changing environment well enough to be able to ride at all is overwhelming even to most experienced riders.

This is not to say that some cyclists do not manage to create problems for themselves anyway. In some countries like the Netherlands which have a strong “bike culture,” “texting while biking” has become common enough to warrant study. Texting while biking, as might be expected, causes riders to slow down erratically, experience decreased awareness, and wobble and veer in and out of the bike lane. This substantially raises the risk of the cyclist hitting an opening car door, running into a pedestrian, wandering into oncoming car traffic, or hitting road debris or a pothole.

Pedestrians fare somewhat better, rarely being inattentive enough to wander into traffic by mistake. Instead, one of the main dangers is that they will slow down to a crawl when crossing the street, exposing them to greater potential danger from distracted drivers. For example, one British study conducted by Anglia Ruskin University found that pedestrians will tend to slow down to what they feel is a safe pace for their level of distraction, finding that pedestrians took, on average, 118 percent longer to cross a given distance while writing a text. 67 percent longer when reading a text, and 83 percent longer when talking on the phone.

Just as with texting and driving, some jurisdictions have likewise tried to target such conduct, with Montclair, California and several other cities having recently opted to impose hefty fines on pedestrians who talk on their phone, look at their phone, or who have headphones on while crossing the street. Results have, likewise, been inconclusive.

It is notable, however, that “distracted walking” of a certain variety, where pedestrians would walk around in the streets without necessarily expecting to have to pay attention to cars, is not an entirely new issue. Streets were, of course, in place long before cars or self-propelled vehicles of any type, and in use by pedestrians long before cars. As such, as self-propelled vehicles (such as road locomotives and early traction engines) began making it to the streets, they had to share them with pedestrians, to the consternation of both. In many cases, legislatures came to the conclusion that these vehicles, which operated at relatively high speeds (for the time) of 10 mph or above, could endanger unsuspecting pedestrians and would scare horses. (Both of these fears were found to be justified.) As such, a variety of solutions were considered, with a common one being the “red flag traffic law.” In some jurisdictions, self-propelled vehicles had to be led by a pedestrian waving a red flag (or, at night, carrying a lantern) in order to warn bystanders of the vehicle's approach, ensuring that pedestrians would be appropriately warned of the vehicle's approach, and limiting the speed at which the traction engine (or other similar vehicle) could operate.

Once motor vehicles started proliferating, however, such “red flag” laws were often seen as far too restrictive. (For example, there is a possibly apocryphal “red flag” law whereby motorists piloting their “horseless carriages”, upon chance encounters with cattle or livestock, would be required to (1) immediately stop the vehicle, (2) “immediately and as rapidly as possible . . . disassemble the automobile”, and (3) “conceal the various components out of sight, behind nearby bushes” until equestrian or livestock is sufficiently pacified.) An early solution for warning other drivers and pedestrians, then, was the vehicle horn, which has historically been an effective method of preventing at least some accidents. History reveals that the vehicle horn was invented around 1908, well over a century ago. The vehicle horn has basically remained a simple, yet effective safety device on vehicles. No-one can deny that the vehicle horn can be credited with saving countless lives and preventing a vast amount of injuries. When the purpose of the vehicle horn is searched on the internet, it is said that the horn's purpose is do “draw attention to potential hazards” and to make one's “presence known.”

However, the world has changed much since 1908, and the vehicle horn has not. For instance, in 1908, users were not intentionally distracting themselves with portable electronic devices designed to block outside sound, and so vehicle horns were not competing for attention against a user's headphones playing music or an e-book, or against a user's hands-free handset that the user is using to make a telephone call Likewise, automobiles were not designed with powerful sound systems used for playing music or the radio, or even providing the user with audio alerts or other messages that can act to distract the user. Finally, such early automobiles were not built to limit the din of diesel buses, sirens, and other vehicle horns. There is no question that the vehicle horn remains an effective safety tool and will be for decades to come. However, the vehicle horn on its own should be recognized as no longer being adequate.

Traffic specialists have realized that certain vehicles need to be made distinguishable in traffic, and have generally opted to provide a combination of light and sound in order to do so. Light is one of the most effective tools in capturing the attention of humans. When light is provided on vehicles, the color of the light on the vehicles is associated with a purpose and meaning. For example, depending on the region, blue and red lights are indicative of police vehicles, fire equipment and ambulances. Vehicles with green lights indicate security vehicles, while purple lights are reserved for funeral processions.

Further, when it comes to amber or yellow lights, most drivers are pre-conditioned to accept a more cautious frame of mind when they observe an amber or yellow flashing light. For example, drivers generally slow down when they see a yellow traffic light (or at least exercise caution when speeding through it), and generally pay more careful attention when they observe amber or yellow flashing lights on construction signs, road warning signs, highway vehicles, wide load convoys, and many other instances where cautionary lighting is used as a visual warning signal.

The “human factor” regarding accidents must also be discussed, because the human factor plays the largest role in automobile accidents. For example, according to the neurophysiology of reactive time, and specifically according to the stimulus response model, human beings have an approximate reaction time of one-half second to events happening around them. This is the time required for the brain's hard-wired laws of association to assemble various sensations in a coherent perception, and then inform the conscious mind (the frontal cortex) that a perceived event requires some analytical reflection and/or some decision-making process on our part. If a conditional reflex suffices to respond to an event, then the one-half of a second reaction time applies. If, however, one's response to an event requires some deeper analysis and judgment, human reaction time can be extended beyond a second or more. Operating a vehicle requires a combination of both types of responses; that is, vehicle operators must exercise both conditional reflexes and analytical judgment. When a vehicle operator is impaired or distracted, that person may have a reaction time that well exceeds the one-half second mark.

It may be possible to command a person's attention by visual reflex. This can be highly context-dependent, and a person's attention can be automatically drawn toward, or away from, certain light sources based on circumstance, and depending on the attributes of the light source. For example, if a person notices a flash of lightning taking place miles away out of their peripheral vision, their attention may immediately be drawn to the area in which the flash occurred. A person's attention can also be drawn by fireworks exploding in the sky within their peripheral field of vision, or the flash of a camera from across a stadium. However, light can also be used in order to deflect attention by visual reflex, should this be desired; for example, it has also long been noted that people will typically look away from a camera flash unless cautioned otherwise, as the bright light of the flash can be dazzling. As such, the exact properties of a light source intended to attract attention, deflect attention, or otherwise induce action must be carefully considered in order to ensure that the light source will have the intended effect.

The visual system in humans is a centrally weighted area of high resolution with extreme sensitivity to movement and to atypicalities in received intensity. Any variation in these two parameters are given priority. Optical recognition in humans is centrally weighted based on motion and intensity not just in terms of visual clarity, but also in terms of consciousness. The area outside of this centrally weighted section is commonly known as one's peripheral field of vision, estimated to be approximately 180 degrees in diameter. Only when some optical observable event of significance occurs, such as a flash of light, will this intrude first into consciousness, then into direct attention with optical scrutiny.

### SUMMARY

An enhanced lighting system that may be used to call direct attention to a vehicle or other hazard may be contemplated. Such a system may provide lighting into a user's peripheral field of vision, thus directing the user's consciousness toward a current priority from among a set of competing interests. Vast improvements in overall safety among complex systems may thus be achieved by the activation of a system such as is set forth herein, which may thus fulfill a long-felt yet unsolved need, where others have failed to develop such a vehicle safety solution.

According to an exemplary embodiment, a vehicle visual signaling device, hereinafter a “VVSD,” may be provided. In some exemplary embodiments, the VVSD may be installed such that it faces the front of a vehicle, and may be provided with at least one light source. In certain exemplary embodiments, the VVSD may be configured such that it uses an independent light source, or may be configured such that it uses an existing light source of the vehicle, such as a hazard light, a spotlight, or a headlight, or a plurality thereof. In certain exemplary embodiments, the VVSD may be mounted on the front of the vehicle, the sides of the vehicle, or a roof of the vehicle and may face forward, or may alternatively face in another direction entirely; for example, in an exemplary embodiment, a VVSD may be coupled to a heavy vehicle such as a tractor-trailer or construction equipment, and may be used in conjunction with or instead of an existing backup warning system. Other variations may also be contemplated; for example, it may be contemplated to have multiple VVSDs provided at multiple angles or at multiple orientations so as to prevent certain types of accidents, and an exemplary VVSD configuration may have a first device oriented forward in order to more properly warn pedestrians, a second and third device oriented at 45 degree angles from the front part of the vehicle (or another such angle) so as to more properly warn a forward vehicle that is attempting to change lanes that the VVSD-equipped vehicle is in a blind spot of the forward vehicle, and a fourth device oriented in a rear direction so as to more properly warn a vehicle that is behind the VVSD-equipped vehicle that it is not slowing down sufficiently and should brake harder to avoid a rear-end collision. (In some exemplary embodiments, movable VVSDs, or VVSDs which can otherwise be angled in an appropriate direction, may also be contemplated.) According to an exemplary embodiment, a light source of the VVSD may be amber or yellow, or may be another color or a combination of colors, such as is desired. According to an exemplary embodiment, a wavelength of light that may be provided by the system may be anywhere from 635 nm (orange light) to 560 nm (yellow light).

According to an exemplary embodiment, an exemplary embodiment of the VVSD may be implemented on a printed circuit board, which may support a microcontroller connected to at least two light sources, at least one power supply, and a vehicle's horn, emergency flasher wiring and at least two radar transmitter/receivers (including a cross-traffic and head-on receiver). The microcontroller may have a code stored thereon for controlling the flashing of at least one light source when the microcontroller receives a predetermined input, such as an input that a vehicle's horn or emergency flashers have been activated, or an input that the radar transmitter/receivers have detected a potential traffic hazard.

According to another exemplary embodiment, a method for attracting the attention of vehicle operators and pedestrians alike may be provided. The method may include providing a VVSD on at least the front of a vehicle. The vehicle may then make use of an active radar in order to detect vehicle operators posing a potential threat of a traffic accident, and pre-caution those vehicle operators by the active radar embodied VVSD. Finally, the VVSD may be activated to flash, which may, for example, be paired with the activation of the vehicle horn or another such device as previously discussed.

Looking now at some exemplary embodiments of the VVSD and methods of using the same, a VVSD may be implemented as follows. A VVSD may have a housing which defines at least one internal cavity, which may hold one or more light sources (such as one or more LED light sources), and may also retain an electronic control system. (In certain embodiments, the electronic control system may be provided in the same cavity, or in a different cavity, such as may be desired.) The housing may have a front opening through which the light source or light sources may face. The electronic control system, which as discussed may be a microcontroller, may be provided within the VVSD and may be used to control the plurality of light sources, and may also be configured to retrieve signals and commands from other parts of the vehicle, such as, for example, the flashers, the horn, or a radar system. (In some exemplary embodiments, a radar system may instead be integrated into the VVSD, or multiple radar systems or other distance-finding systems may be used, such as may be desired.) For example, the electronic control system may have a signal output from at least one of the set of: a vehicular radar system, the vehicular radar system being directed towards a front of the vehicle and including a transmitter and receiver; a vehicle horn electrical system communicatively coupled to a vehicle horn; and an emergency flasher electrical system communicatively coupled to a vehicle emergency flasher.

According to an exemplary embodiment, in a configuration whereby the VVSD is integrated with a radar system, it may also receive a signal output from a laser distance measurement system such as a light detection and ranging (LIDAR) system, which may also be integrated with the VVSD or may be a separate device, such as may be desired. (For example, in various exemplary embodiments, a radar system, a laser system, a radar/laser system that combines data from both devices, or another vehicular range-finding tool may be used. For example, it may also be contemplated to include a vehicular ultrasonic system, or an optical sensor such as a forward-looking infrared (FLIR) system, or some combination of any or all of the above systems or other range-finding tools, such as may be desired.) The radar system may, in some exemplary embodiments, be used to give the VVSD a 10-degree zone of coverage, or a narrower or wider set of coverage (which may be adjustable), such as may be desired.

In an exemplary embodiment, the light sources of the VVSD may be light-emitting diodes (LEDs). Alternatively, they may be high-intensity discharge lamps (HIDs). In certain exemplary embodiments, these light sources may be configured to emit light at a wavelength of 635 nm (orange light) to 560 nm (yellow light), or any wavelength in between. Other wavelengths are also contemplated, as well as embodiments whereby multiple wavelengths of light are provided. (For example, a primary light source may be provided having a 635-560 nm wavelength, and a secondary light source may be provided having a wavelength outside of this range, for example a 560-520 nm wavelength for conditions of different visibility.)

In an exemplary embodiment, the electronic control system may have a connection to the vehicle horn wiring harness, such that the electronic control system is configured to receive an electrical signal from the vehicle horn wiring harness and is configured to illuminate the light source or light sources when an electrical signal is received. Alternatively, or additionally, the electronic control system may have a connection to an emergency flasher, and may be configured to receive an electrical signal from the emergency flasher and is configured to illuminate the light source or light sources when an electrical signal is received. The electronic control system may be configured to match a duty cycle of the light source with a duty cycle of the flasher, or may otherwise be configured to illuminate the plurality of light sources based on a duty cycle of the emergency flasher.

The VVSD may further have a curtain disposed around the front opening of the housing, which may in some exemplary embodiments be formed from a flexible material, such as rubber or foam. (Other materials, such as more rigid materials, are also possible, and may be favored when the VVSD is intended to work with a specific vehicle with a known windshield contour, if desired.) In an exemplary embodiment, this curtain may completely surround the front opening, ensuring that the VVSD only projects light outward and does not project it into the cabin of the vehicle, limiting the extent to which it inconveniences the user or interferes with the user's night vision.

In an exemplary embodiment, the internal cavity of the VVSD in which the light source is disposed may have a reflective finish. Multiple internal cavities, which may or may not be reflective, may be contemplated; for example, each of several light sources may have their own cavity, and a separate nonreflective cavity may be provided for the electronic control system.

In an exemplary embodiment, the VVSD may be integrated into a vehicle, with the VVSD being integral with a body of the vehicle, or being a separate peripheral, such as a peripheral disposed on the interior of the vehicle such that the front opening of the visual warning device is directed at a windshield of the vehicle. In such a configuration, the VVSD may have a curtain adhered to the interior of the vehicle windshield. Other configurations (such as a VVSD disposed on the exterior of the vehicle as a separate peripheral) may also be contemplated. Any of the other devices with which the VVSD may be paired, such as a vehicular radar system, may also be integral with the body of the vehicle or may be separate devices, such as may be desired. The VVSD may be integrated with other components of the vehicle, such as acceleration sensors or vehicle engine sensors, such that the VVSD may only be enabled when the vehicle is in motion, and is put on standby when the vehicle is stopped.

A method of using a VVSD may also be contemplated. Such a method may include the steps of detecting, with a vehicular radar system, the vehicular radar system being directed towards a front of the vehicle and including a transmitter and receiver, at least one of a head-on object or a cross-traffic object; signaling, with an output of the vehicular radar system, an electronic control system, and activating, with the electronic control system, the VVSD. Different behaviors may also be contemplated for certain objects or certain object behaviors; for example, a VVSD may be configured to only activate when cross-traffic is moving, and as such may, upon detecting a cross-traffic object, determine if the cross-traffic object is moving, and, when it is, may send a signal from the vehicular radar system to the electronic control system and activate the light source or sources of the VVSD. Further, as mentioned, other vehicle behaviors, such as the motion or absence of motion of the VVSD vehicle, may also be taken into account.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 shows an electrical schematic of an exemplary embodiment of a vehicle visual signaling device;

FIG. 2 shows an electrical flowchart schematic of an exemplary embodiment of a VVSD;

FIG. 3A shows an exploded view exemplary embodiment of a VVSD;

FIG. 3B shows an exemplary embodiment of a VVSD;

FIG. 3C shows an exploded view exemplary embodiment of a VVSD;

FIG. 3D shows an exemplary embodiment of a VVSD;

FIG. 4A shows an exemplary placement location of a VVSD;

FIG. 4B shows an exemplary placement location of a VVSD;

FIG. 4C shows an exemplary placement location of a VVSD;

FIG. 5A shows an exemplary light projection pattern of a VVSD;

FIG. 5B shows an exemplary light projection pattern of a VVSD;

FIG. 6A shows an exemplary zone of coverage for a radar transmitter/receiver (cross-traffic); and

FIG. 6B shows an exemplary zone of coverage for a radar transmitter/receiver (head-on traffic).

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

According to an exemplary embodiment, and referring generally to the Figures, various exemplary implementations of a vehicle visual signaling device (VVSD) may be disclosed. In certain exemplary embodiments, such a vehicle visual signaling device, or VVSD 10, may be complementary to a vehicle's existing horn and emergency flasher system. In some exemplary embodiments, a VVSD 10 may additionally be a visual warning notification system that provides operators of other vehicles posing a potential traffic hazard situation. This may be achieved, for example, by an exemplary embodiment of a VVSD 10 that may make use of radar.

In an exemplary embodiment, the VVSD 10 may be designed to enhance the effectiveness of a vehicle's traditional horn and emergency flashers. For example, the VVSD 10 may, when activated, illuminate a high intensity amber or yellow flashing light, which may penetrate the peripheral field of vision of distracted or impaired individuals. (In certain exemplary embodiments, different colors, or multiple colors, may be contemplated, which may be activated based on certain conditions. For example, it may be noted that, in the daytime, human eyes can most easily pick up green light, because cones, used for color vision in conditions of high light, may be most sensitive to green light. However, it may also be noted that green, yellow, and blue light tend to fade into the background a little more than red light, even though red light cannot be as easily seen. As such, it may also be contemplated to use a green light for visibility despite the associations of this light color with a lack of warning, or may be contemplated to use a red light in order to ensure that the light is seen as a warning and quickly distinguished from the background. Combinations can also be contemplated; for example, an exemplary VVSD 10 could flash between green and red for enhanced visibility and enhanced distinguishability. It may further be noted that yellow can be most easily distinguished in conditions of low light, when the eyes make greater use of rods than cones, and as such may be contemplated to use amber or yellow light at night even if another color or set of colors is provided during the day.

In an exemplary embodiment, the light or lights of the VVSD 10 may be flashed for a predetermined time period, such as for approximately a one second period of time. In other exemplary embodiments, flashing may occur continuously while a hazard is present, or while a response to a hazard (such as a depressed brake pedal) is noted to be present. (Other variations may also be contemplated; for example, it may be contemplated to have the flashing light vary in light intensity or in flashing intensity as the brake pedal is depressed or as the hazard remains detected, such that a depression in the brake pedal causes the light to flash more quickly over time in order to ensure that the flashing is recognized, flashes with a higher light intensity over time for the same reason, or flashes with a lower light intensity over time such that a person is not blinded by the light and is able to react.)

As such, according to the reasons outlined above, a light, such as an amber or yellow flashing of light, may be utilized in a VVSD 10 for capturing the attention of distracted or impaired individuals.

According to an exemplary embodiment of a VVSD 10, a VVSD 10 may have a microcontroller 206 or other electronic control system, and may have one or more light sources, such as LEDs 220, which may be controlled by the microcontroller 206 or other electronic control system. According to some embodiments, it may be contemplated to have the microcontroller 206 and LEDs 220 housed in the overall same structural housing/shell 300. In an exemplary embodiment wherein the microcontroller 206 and LEDs 220 are housed in the same overall structural housing, it may be contemplated to have the microcontroller and the LEDs separated by a partition 302 that may have a reflective, chrome-like finish that faces outside of the housing structure lens 308 and faceplate 310. (It may likewise be contemplated to have the internal portion of the structural housing or housings of the LEDs be similarly reflective, if the microcontroller 206 and LEDs 220 are not housed in the same overall structural housing.)

In an exemplary embodiment, the partition 302 may serve as a mounting platform and reflective housing for the LEDs 220 and radar transmitter/receivers 304 and 306. Further, in an exemplary embodiment, the LEDs 220 and microcontroller 206 may be remote from one another and connected by a male/female connection 242 for the purpose of the ease of manufacturing and installation, where the microcontroller 206 and LEDs 220 may be an undetermined distance apart from one another. It may be highly anticipated that different manufacturers may customize a VVSD 10 to custom fit specific vehicle models and ensure that the signal lighting device is aesthetically appealing to their particular product lines.

According to various exemplary embodiments of the VVSD 10, multiple materials may be contemplated, which may, for example, vary based on whether the VVSD 10 is integrated into the remainder of the vehicle design or whether the VVSD 10 is a separate device that may be retrofitted onto the vehicle. For example, in various exemplary embodiments, the components of the VVSD 10 may be manufactured with automotive grade plastic, fiberglass, carbon fiber, composite or metal material. For external application, a material used may be paintable and may be weather resistant to match the vehicle paint scheme, such as may be desired. Further, as noted, the housing structure for the microcontroller 206 and LEDs 220 may be pre-existing in a vehicle which the VVSD 10 is being installed; for example, in an exemplary embodiment, the VVSD 10 may be a device mounted in a specific location on the vehicle body, such as on the backs of the vehicle rear-vision mirrors, under the headlights, integrated with the headlights such that the same LEDs can be used for either purpose, or in any other location such as may be desired.

As such, it may be understood that varying housing structures may not take away from the purpose and spirit of the VVSD 10 if it is manufactured and installed as described herein. The figures, generally, may provide for and outline the process and components that may in some exemplary embodiments allow for the simultaneous flashing of LEDs, such as high intensity amber or yellow LEDs 220, at an appropriate flashing rate, such as approximately 6 flashes per second.

Applicant notes that, in an exemplary embodiment, a flashing rate of approximately 6 flashes per second with a duty cycle of 50% on and 50% off time may function as an optimal setting for the device, and may in some exemplary embodiments function as a default setting. However, it may be understood that the use of such a flashing rate may be a recommendation only and in no way precludes one from adjusting either the flashes per second or changing the one second flash interval. In fact, doing so does not change the overall purpose of, or the spirit of the VVSD 10. However, it may or may not change the effectiveness for better or worse. (For example, it may be contemplated that variations on this may be more appropriate in certain circumstances or in certain external conditions; for example, it may be desirable to use a shorter or longer flash interval or use a greater or smaller number of flashes per second when the vehicle detects that it is in rainy conditions, foggy conditions, snowy conditions, or any other such conditions such as may be desired.)

According to an exemplary embodiment, any light source or combination of light sources may be used. For example, according to an exemplary embodiment of a VVSD 10, a VVSD 10 may utilize LEDs due to increased reliability and vibration resistant properties, which may not be characteristics of incandescent bulbs. Furthermore, LEDs may become fully illuminated faster than incandescent bulbs by ⅔rds of a second and have an average of 30,000 to 50,000-hour life span. In other exemplary embodiments, other light sources may of course be contemplated. For example, it has become increasingly common to make use of high-intensity discharge, or HID, lamps in vehicle lighting, with metal-halide and ceramic metal-halide lamps being common for use in vehicle headlights. (HID lamps are a type of electrical gas-discharge lamp which produces light by creating an electric arc between tungsten electrodes, which may be housed inside a transparent arc tube filled with noble gas and one or more types of metal salt. The noble gas enables the arc to initially bridge the gap between the two electrodes, with the arc then heating up the metal salt and evaporating it, generating a large amount of visible light per unit of electric power consumed as compared to other types of lighting such as incandescent and fluorescent lighting.) For example, it may be contemplated to use a low-pressure sodium lamp, which may be capable of providing a light source in a highly distinctive deep yellow-orange color, at a high brightness and high efficiency.

(It is noted, for example, that in some cases a certain type of lighting may be less desirable due to, for example, the choices of a municipality or other organization in providing street lighting, or other ambient light conditions. For example, it is noted that low-pressure sodium vapor lamps have been used in street lighting and still are preferred in some cases, meaning that it may not be desirable to use an amber or yellow light in the VVSD 10, as this may not be readily distinguishable from the street lighting. As such, in order to ensure that the VVSD 10 can display light in a color that is distinguishable from the background, it may, for example, be contemplated to use multiple light sources in the VVSD 10, such as a bluish-green mercury-vapor HID lamp and a low-pressure sodium HID lamp, or a dynamic LED cluster, with the VVSD 10 further comprising an external light sensor configured to detect an ambient light condition and provide an appropriate light source.)

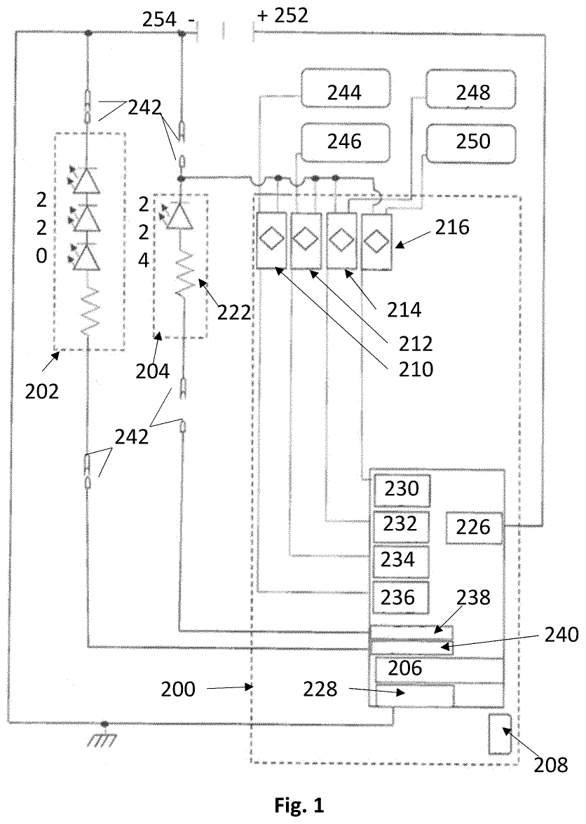

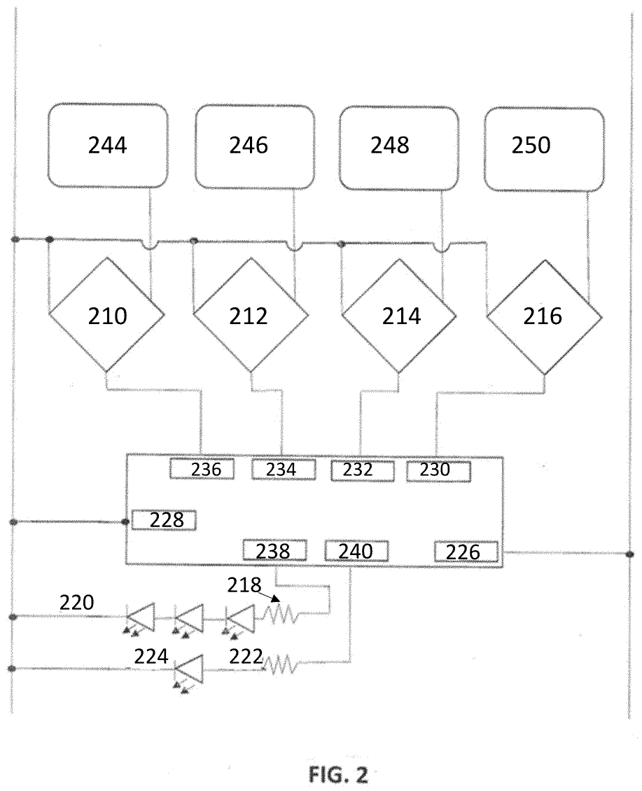

Now referring to exemplary FIGS. 1 and 2, an electrical diagram and flow chart of the components of the VVSD 10 may be provided. As referenced below, the VVSD 10 may have PCBs 202 and 204, which may support resistors 218, 222 and LEDs 220 and 224. These components may be communicatively coupled by way of connectors 242 to components of PCB 200. Components of PCB 200 may include one or more voltage sensors 210, 212, 214, 216, inputs 230, 232, 234, 236, voltage input 226, outputs 238 and 240, one or more microcontrollers 206, a ground 228, and one or more serial ports 208. The electrical schematic of FIG. 1 may further show a power source 252, a horn current or signal output 244, an emergency flasher current or signal output 246, a cross-traffic radar transmitter/receiver current or signal output 248, and a head-on radar transmitter/receiver current or signal output 250.

According to an exemplary embodiment, a VVSD 10 may include a microcontroller or in some alternative embodiments a microprocessor. In some further embodiments, multiple microcontrollers or microprocessors may be utilized, as well as additional components, such as timers, resistors, voltage regulators, shunts, capacitors, voltage sensors, emitters, diodes, controllers, switches, Zener diodes and the like, which may optionally be installed on at least one printed circuit board (PCB). It may also be contemplated to have the VVSD 10 be operated by a vehicle processor which may likewise be configured to perform other tasks, if such is desired.

According to an exemplary embodiment, it may be contemplated for the VVSD 10 to make use of radar technology for range-finding and motion detection. However, this does not preclude the radar technology from being replaced with or used in conjunction with some alternative configuration, such as radar/laser, laser, or maser technology, or any other range-finding technology such as may be desired. All have been examined and may be incorporated into the manufacturing of a VVSD 10. (It may further be contemplated to have the VVSD 10 take advantage of any native range-finding capabilities of the vehicle, if the VVSD 10 is an external device. For example, it may be that the vehicle is equipped to perform range-finding with radar, but not with laser range-finding. A VVSD 10 may provide laser range-finding, and may also have a data connection to the vehicle so as to make use of the results from the vehicle's radar rangefinder.)

In some embodiments, LEDs may be provided in series; however, in other embodiments, a microcontroller or microprocessor may be capable of providing sufficient inputs and outputs to run LEDs in parallel or to enable them to operate independent of one another. In an exemplary embodiment, the VVSD 10 may receive power from a vehicle; it may also be contemplated to have the VVSD 10 receive power from any other power source, such as an internal battery, or have the VVSD 10 operate using another type of light source such as a chemical light source, such as may be desired. The VVSD 10 may be tapped or spliced into the vehicle's existing wiring system or in some embodiments a separate wiring harness may be provided. The microcontroller and light source, such as the amber or yellow LEDs, may receive a constant power supply from a vehicle in order to perform specific timed functions, as described herein. LEDs 220 and 224 may not be illuminated until the circuit is closed by the microcontroller. The circuit may include a connection between the vehicle and a ground, such as the chassis. The microcontroller may be grounded through the vehicle chassis ground, as may be the LEDs 220 and 224 when the circuit is closed. The LEDs 224 may illuminate a visual notification, which may optionally flash, within the passenger compartment of a vehicle to indicate the VVSD 10 has been activated. This example does not preclude an optional VVSD 10 audio notification, nor does it preclude an embodiment where the vehicle horn is activated simultaneously with the flashing lights of the VVSD 10.

The microcontroller 206, according to at least one embodiment, may receive a signal or current from the vehicle's existing horn wiring system 210 and 244, optionally by way of a wiring harness connection, when the horn button is depressed and the audio horn is activated. This incoming signal or current 210 may activate an integrated switch within the microcontroller 206 which may close the circuit between the constant power supply from the vehicle, the LEDs/resistors 218, 220, 222, 224 and the chassis ground 254. Once the microcontroller 206 closes this circuit, allowing current to flow, the microcontroller 206 may perform preprogrammed functions. One function of the microcontroller 206 may to be to flash the light source, such as the amber or yellow LEDs 220, with an integrated flash timer. For example, according to an exemplary embodiment, the light source may be flashed 6 times in approximately one second in a 50% on and 50% off duty cycle. A second function of the microcontroller 206 may concern a second integrated timer which may open the circuit, stopping current from flowing between the vehicle power supply 262, the LEDs 220 and the vehicle chassis ground 254 which may prevent the LEDs 220 from flashing after approximately 1 second has elapsed.

The microcontroller 206 may reset the one second timer once the horn button is no longer being depressed. It should be noted that any of the individual components which may replace the microcontroller 206, or which may be used in conjunction with the microcontroller 206, may be incorporated into the printed circuit board or may be incorporated into the VVSD 10 at any other stage of the manufacturing process, such as may be desired.

Further, in an exemplary embodiment, the microcontroller 206 may receive a separate signal or current from the tap or splice of the existing wiring harness of the vehicle emergency flashers 246. Once the signal or current is received from the emergency flasher voltage sensor 212, the microcontroller 206 may close the circuit including the vehicle power supply 252 through the LEDs 220 to the chassis ground 254. The microcontroller 206 may allow for the current to flow only when it receives a signal or current from the vehicle's emergency flasher wiring harness 246 indicating that the vehicle's front emergency flashers, which may, for example, commonly be front amber or yellow, LEDs, or clear bulbs or LEDS with amber or yellow lenses or filters, are illuminated. This signal may cease being sent to the microcontroller 206 when the bulbs or LEDs to the vehicle's emergency flashers are not receiving current. The signal or current from the emergency flashers may run in a duty cycle, which may, for example, be a duty cycle of 50% on and 50% off. In such an embodiment, the vehicle's emergency flashers may be illuminated half of the time and not illuminated half of the time. When the vehicle's emergency flasher bulbs or LEDs are illuminated, the signal or current may be sent to the microcontroller 206 to close the circuit, allowing current to flow as defined above. The microcontroller 206 may command the VVSD 10 light source, which may for example be the amber or yellow LEDs 220, to flash at a rate of approximately 6 flashes per second, which may cause the VVSD 10 to be energized simultaneously with the duty cycle of the existing emergency flashers. If, for example, the vehicle's existing emergency flasher bulbs or LEDs operate at a duty cycle of 1 second on and 1 second off, at a resultant rate of 30 flashes per minute, the VVSD 10 light source, such as amber or yellow LEDs 220, may flash approximately 180 times in that same one-minute period of time.

According to an exemplary embodiment, it may be contemplated that the VVSD 10 may make use of a radar system. It may be contemplated that, generally, there are four basic components to a radar system: a transmitter, antennas, a receiver, and a display. In the following embodiments, the transmitter may be configured to produce a signal that is sent out and received by the antennas, which is then passed to the receiver. The receiver may then be programmed to analyze the return signal, and then send said return signal to the display, allowing the return signal to be perceived by a human. For the purposes of the VVSD 10, in some exemplary embodiments, a microcontroller may replace the traditional radar display in order to perform the functions outlined herein, if desired.

Concerning the head-on collision radar; the microcontroller 206 may receive a third, separate signal or current from the radar head-on signal/current output 250, which may be purposed to detect a direct oncoming vehicle in the path of the subject vehicle. Once such an oncoming vehicle is detected and the radar head-on signal/current output 250 transmits the signal or current to the voltage sensor 214 and further transmits the signal or current to the microcontroller 206, the microcontroller 206 may close the circuit including the vehicle power supply 226 through the LEDs/resistor 218, 220, 222, and 224 to the chassis ground 254. This may command the amber or yellow lights to flash, bringing attention to the potential traffic hazard. The microcontroller 206 may allow for the current to flow only when it receives a signal or current from the radar warning system that the threat of a head-on collision is present. Once the sensor has detected that the threat has passed, the signal or current to the microprocessor 206 may be stopped, opening the circuit between the vehicle power supply 226, LEDs/resistor and the chassis ground. This embodiment may command the amber or yellow LEDs 220 to flash at a rate of approximately 6 flashes per second all the while the circuit is closed, commanding the attention of the head-on approaching vehicle.

Concerning the head-on radar feature for the purpose of this embodiment, the range of this embodiment may be established by calculating a distance long enough to enable the operator of the approaching vehicle ample time to observe the amber or yellow flashing lights 220 and to make an evasive maneuver in order to avoid a head on collision with the subject vehicle. For example, it may be contemplated to have the amber or yellow flashing lights 220 (or other light source) activate when the system calculates that a collision may occur within a predetermined number of seconds if the course of one of the vehicles is not corrected.

In certain exemplary embodiments, it may be contemplated to have various different zones of coverage for the radar and/or other detection systems which may be contemplated for use with the VVSD 10. For example, in one exemplary embodiment, a straight narrow signal may be sent directly in front of the path of the subject vehicle. Using a programed display function, the outgoing signal may be directed so as to bounce off only vehicles heading directly toward the subject vehicle, or other obstacles which the vehicle may be directly approaching. The radar may detect successive wavelengths closer than the one before it and may report this information to the display.

In this embodiment, the head-on signal/current output 250 may use a moving target indicator, MTI, which may dismiss any non-moving vehicles and vehicles travelling in the same direction as the target vehicle. Finally, this embodiment may activate whenever a VVSD 10 equipped vehicle is in forward motion.

According to an exemplary embodiment, it may also be contemplated to detect cross-traffic via a cross-traffic radar current output 248. For example, in an exemplary embodiment of a cross-traffic radar current output 248, the microcontroller 206 may receive a fourth separate signal or current from a radar head-on signal/current output 250 purposed to detect cross-traffic vehicle movement from an undetermined distance away that potentially could cut off the subject vehicle. For example, subject vehicle is traveling northbound, equipped with a VVSD 10 such as is contemplated herein. A target vehicle may be traveling westbound, approaching the subject vehicle's path. Once the subject invention detects the potentially dangerous situation, the signal or current is received by the microcontroller 206, and transmitted through the voltage sensor 216. The microcontroller may close the circuit including the vehicle power supply 252 through the LEDs/resistor 218, 220, 222, and 224 to the chassis ground. This may command the amber or yellow lights to flash, bringing attention to the potential traffic hazard. The microcontroller 206 may allow for the current to flow only when it receives a signal or current from the radar cross-traffic current output 248 that the threat of a collision is present. Once the threat has passed, the signal or current to the microprocessor 206 may be stopped, opening the circuit between the vehicle power supply 252, LEDs/resistor 218, 220, 222 and 224 and the chassis ground 254. This embodiment may command the amber or yellow LEDs 220 to flash at a rate of approximately 6 flashes per second all the while the circuit is closed. (Other variants may of course be contemplated.)

According to an exemplary embodiment, it may be contemplated to target only a moving vehicle on the approaching right hand side of the subject vehicle. This may be accomplished by limiting the beam width to a narrow degree range on the right-hand side of the vehicle, for example to an optional 10 degrees. To accomplish a desired beam width, radar/laser technology may be utilized, as would be understood by a person having ordinary skill in the art.

In an exemplary embodiment of a cross-traffic radar feature, the zone of coverage may be set at an optional 10 degrees, though other ranges may be contemplated. Where this device is purposed for detecting only cross traffic coming from the right side that could potentially pull out in front of the subject vehicle, additional features may be considered as well. For example, in an exemplary embodiment, the radar system may use a moving target indicator, MTI and/or a plan position indicator, PPI, that may not report any vehicles that are not moving, as they pose no threat. (It may be contemplated, for example, for such an exemplary embodiment to make use of an exemplary range of approximately 100 feet.) Finally, it may be contemplated that this embodiment may not be active when the VVSD 10 equipped vehicle is not in forward motion. (Other exemplary embodiments are of course contemplated. For example, while in some exemplary embodiments it may be contemplated not to report any vehicles that are not moving and which are not straight ahead, in other exemplary embodiments it may be contemplated to report certain vehicles which may be detected within the zone of coverage of the cross-traffic indicator, such as vehicles detected as being stalled on the shoulder of a highway. It is generally recommended for drivers to change lanes or slow down anytime they are approaching a vehicle that is slow-moving, stopped, or stranded on the shoulder, if they can safely do so, because of potential safety hazards such as other drivers exiting the vehicles. As such, the VVSD 10 may be used in order to determine when the driver should slow down or change lanes in order to ensure that they can safely pass the vehicle.)

For reference, a moving target indicator, or MTI, is a mode of operation of a radar by which the radar may specifically discriminate a target against the clutter. An MTI radar may make use of low pulse repetition frequency (PRF) and may begin MTI operations by sampling two successive pulses. Once a radar transmit pulse has been taken, sampling may begin immediately, and may continue until the next transmit pulse begins. Sampling may then be repeated, in the same location, for the next transmit pulse, and the sample taken (at the same distance) with the first pulse may then be rotated 180 degrees and added to the second sample to create destructive interference. If an object is moving in the location corresponding to both samples, then the signal reflected from the object will survive this process because of constructive interference. If all objects are stationary, the two samples will cancel out and very little signal will remain. MTI techniques may be combined with stationary target indication (STI) techniques, which targets some intrinsic characteristics of the target which are different from the characteristics of the surrounding clutter (such as a specific known object size); for example, it may be contemplated to provide both forms of target identification in a combined mode called stationary and moving target indication (SMTI).

A plan position indicator (PPI) may be a type of radar display that may represent the radar antenna in the center of the display, with the distance from the radar antenna being provided as concentric circles. The radar antenna may operate by sending pulses around an area (typically an area 360 degrees around the antenna, at a fixed elevation angle), and the returns from these pulses will then be represented by the PPI. PPIs are generally the most common and most recognizable type of radar display.

Looking again specifically at the VVSD 10, as explained, the operation of the VVSD 10 may have multiple purposes. That is, the VVSD 10 may be activated once the microcontroller 206 receives a signal or current from the existing horn wiring harness 224, allowing the VVSD 10 to perform as described above. It can also be activated when separate inputs in the microcontroller receive a signal or current from the existing wiring harness to the vehicle's emergency flashers 246, or the radar head-on and cross-traffic signal/current outputs 248 and 250.

In some embodiments, the VVSD 10 may optionally be limited to one application or a limited selection of the applications provided herein. For example, the VVSD 10 may be limited to the specific application of providing an enhanced visual notification when a vehicle's horn is sounded, as detailed above, and not the other functions as described above, and vice-versa. In such embodiments, the VVSD 10 might not be tapped or spliced, or may not be configured to receive a signal or current from an undesired embodiment in order to avoid transmitting a signal or current to the microcontroller. This may in no way affect the operations of the remaining application or applications, and example VVSD 10 devices contemplated herein may be capable of executing all, some, or none of the contemplated functions without those functions being impaired by the combination of features.

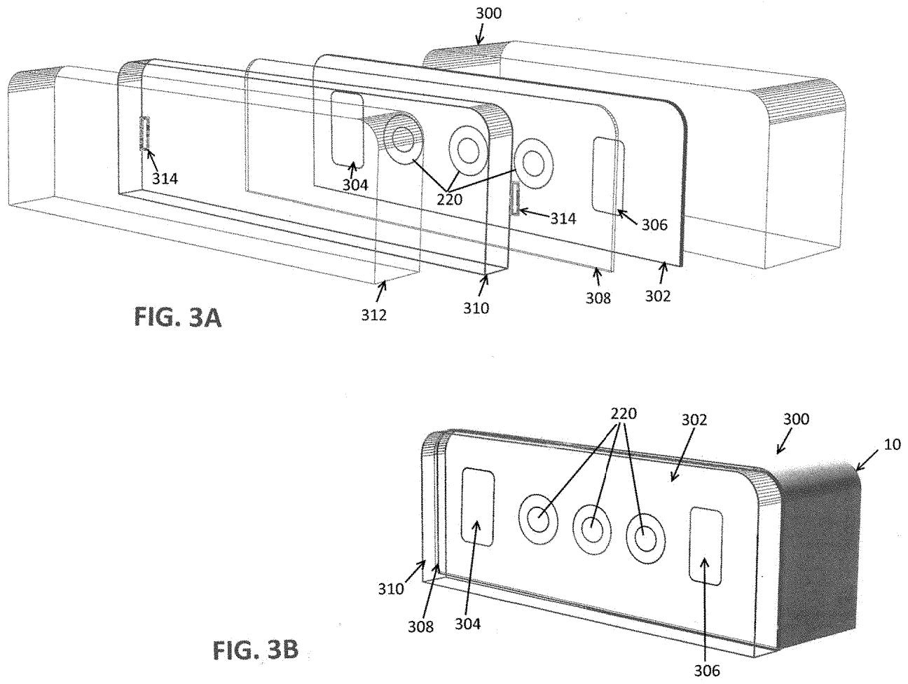

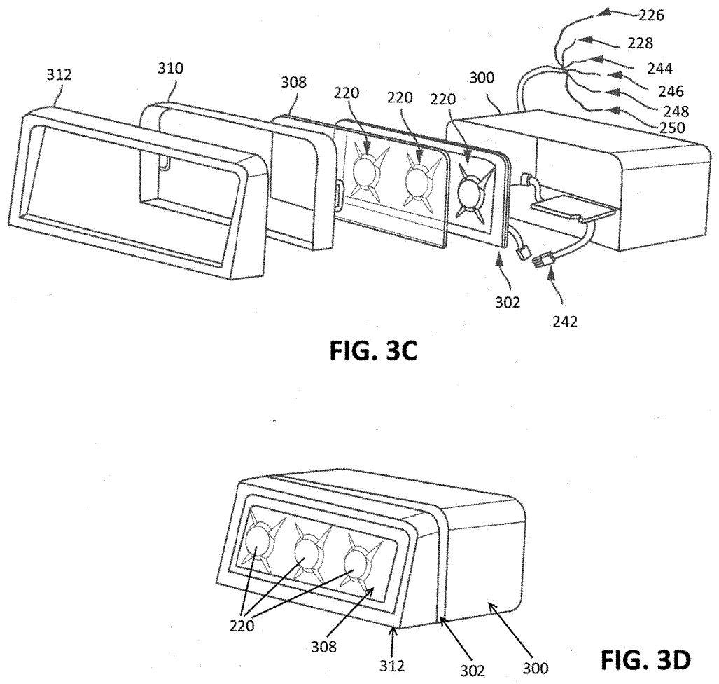

Turning now to FIGS. 3A and 3B, FIGS. 3A and 3B may show a VVSD 10. In an exemplary embodiment, the components of the design may be mounted in a housing structure/shell 300. In some embodiments, the components may be mounted using a temporary or a permanent fastener, such as tape, double-sided tape, adhesive, screws, or other fasteners, such as would be understood by a person having ordinary skill in the art. A wiring harness from the microcontroller containing lead wires for connections to components may be fed through a wall or shell and may be connected to the signal or power source as defined above. In an exemplary embodiment, lead wires may be fed through a rubber grommet, which may optionally be airtight and/or watertight.

According to an exemplary embodiment, the LEDs 220 may be mounted to a LED mount 302, which may be a reflective partition designed to reflect the amber or yellow lights of the LEDs 220 through a clear lens 308. The clear lens 308 and the aforementioned LED partition 302 housing the LEDs 220 may be attached, optionally by snap fit, adhesive, or other fasteners, to the rear portion of the faceplate 310. A wiring harness from the LEDs 220 may be connected to a microcontroller 206 utilizing male/female connectors 242. A faceplate 310 may be secured to the housing structure or shell 300. In some embodiments, lens 308 may be implemented within faceplate 310. Faceplate 310 may be secured by a snap fit construction, adhesive, or other fasteners understood in the art. (For example, in the depicted exemplary embodiment, fasteners 314 may be depicted as a snap fit.) In an exemplary embodiment, the components detailed above may be joined together as a single unit.

It may further be contemplated to provide a curtain 312 in order to facilitate installation of the device in an appropriate position on the vehicle, such as on a dashboard, against the front windshield. This may specifically allow the system to be paired with any of a variety of windshields, which may have a variety of shapes (such as flat or rounded shapes) and may be disposed at a variety of angles, such as may be desired. In some embodiments, curtain 312 may be a soft rubber or foam-like material, such that the curtain 312 can readily conform to the shape of the windshield and sit flush against it. According to an exemplary embodiment, it may also be contemplated for curtain 312 may have a variety of shapes, sizes and angles to fit a desired vehicle, whereby a particular curtain 312 may have a tapered angle matching the slope of a specific vehicle's front windshield. (In such exemplary embodiments, the curtain 312 may be more rigid, if desired.) In an exemplary embodiment, curtain 312 may be an interchangeable piece, such that an appropriate curtain 312 may be selected for better conformity to a particular windshield. A vehicle visual signaling device 10 may thus be provided with multiple soft rubber-like or foam curtains 312 that can be selected to provide the best angle for the installation of the device onto the front windshield or other vehicle location. In an exemplary embodiment, the rubber-like or foam curtain 312 may have double-sided tape or adhesive disposed on a front surface and/or rear surface in order to permanently (or at least more fixedly) adhere the curtain 312 to the windshield. In an exemplary embodiment, one side of the curtain 312 may be adhered to the front of the faceplate 312 and the other side may be adhered to the vehicle's front windshield. The soft rubber-like or foam curtain 312 may prevent light from LEDs 220 from bleeding through into the interior of the passenger compartment of a vehicle.

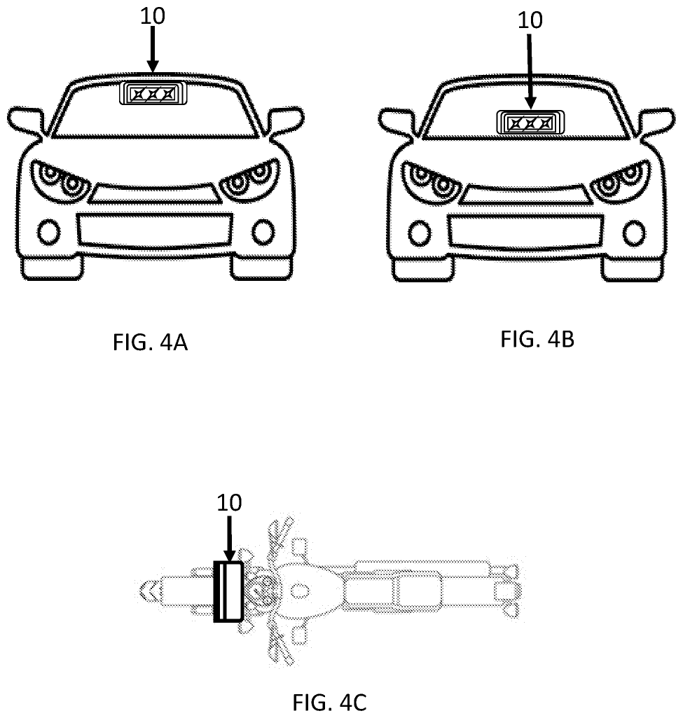

Now referring to FIGS. 4A, 4B, and 4C, the VVSD 10 may be installed in a variety of locations on a vehicle, and may be installed on a variety of vehicles. As shown in FIG. 4A, a VVSD 10 may be installed on the front windshield directly in front of the rear-view mirror. Further, in another embodiment shown in FIG. 4B, the VVSD 10 may be installed in the center of a vehicle dashboard. In another embodiment, shown in FIG. 4C, the VVSD 10 can be installed onto the top of a motorcycle headlight assembly. As would be understood by a person having ordinary skill in the art, a VVSD 10 may be affixed in a desired location on a vehicle component (such as as an internal or an externally-mounted device, such as is desired) or may be integrally installed in a vehicle, such as a front fender of a motorcycle, or the front dash assembly of a passenger car. In other exemplary embodiments, a VVSD 10 may be used in any kind of vehicle, such as trucks, buses, RVs, OHRVs, ATVs, snowmobiles, air or marine vehicles, or any other type of vehicle, including vehicles that are already made high-visibility like construction equipment.

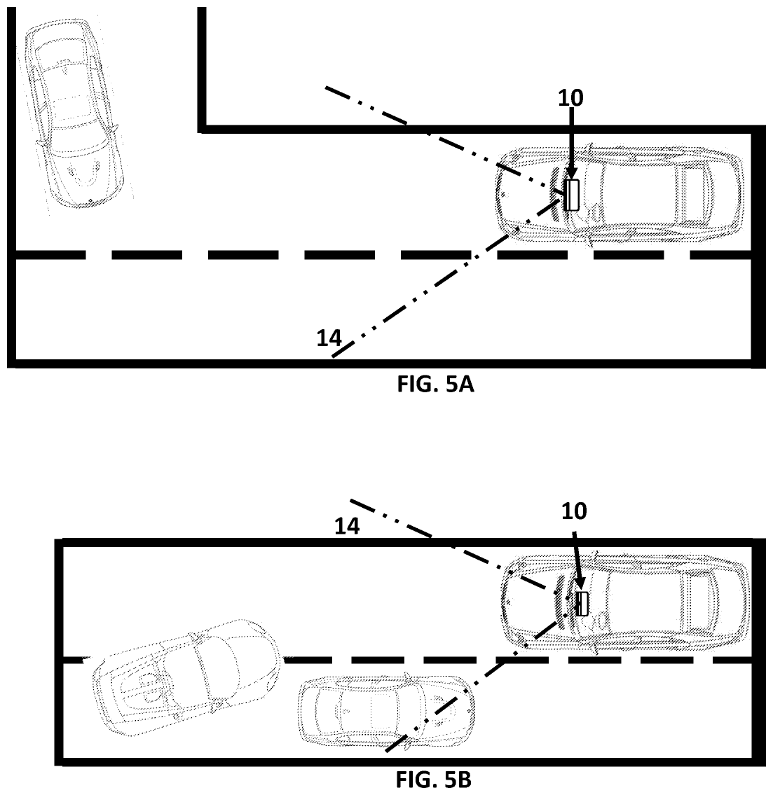

Now referring to FIGS. 5A and 5B, an exemplary projection pattern 12 of a VVSD 10 may be shown. In an exemplary embodiment, the signal lighting device may project a beam width of approximately 10 degrees. To accomplish a desired beam width, a light source of a VVSD 10 may be placed at an appropriate depth within a housing, such that, when it is desired to produce a tighter beam width, the light source of the VVSD 10 is moved further back into the housing, whereas when it is desired to produce a wider beam width, the light source of the VVSD 10 is moved frontwards in the housing. In some alternative embodiments, curtains or sidewalls may extend from the VVSD 10 housing in order to guide the projection pattern 12. Furthermore, some embodiments may use light deflection devices, focusing elements, or filters, as would be understood by a person having ordinary skill in the art. The techniques and devices for creating a desired projection pattern may also be adjustable.

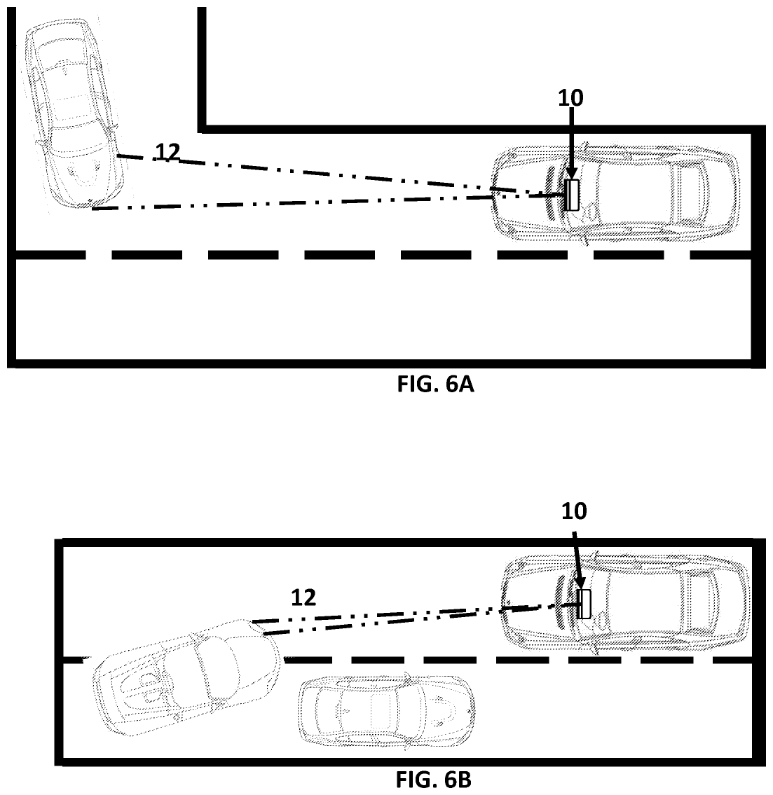

Now referring to FIGS. 6A and 6B, an exemplary projection of the zone of coverage 14 may be shown. In various exemplary embodiments of the VVSD 10, different projections may be provided, such as a narrower projection 12 as provided in FIG. 6B or a wider projection 12 as provided in FIG. 6A. According to an exemplary embodiment, in order to accomplish the desired projection for the zone of coverage, different exemplary embodiments of the VVSD 10 may make use of a combination of radar and laser technology, or any other contemplated techniques, such as would be understood by a person having ordinary skill in the art.

According to an exemplary embodiment, the techniques, or even the devices, that may be used for creating a desired zone of coverage projection pattern may optionally be adjustable. For example, it may be contemplated to have a VVSD 10 make use of a different radar sweep pattern, or provide a laser with a different power level based on a desired range of the projection. For example, in one exemplary embodiment, it may be contemplated that two or more lasers, such as two or more laser diodes, may be provided and may be selectively excited, with each of the lasers having a different threshold current at which lasing begins and having different power characteristics, so as to produce different laser outputs. To give one example, it may be contemplated that a laser diode configured to provide 5 mW may be visible at a greater distance than a laser diode configured to provide 1 mW; thus, the laser diode configured to provide 5 mW may allow greater ranges for the VVSD 10 than the laser diode configured to provide 1 mW. However, it may be contemplated that the threshold current needed to drive the 5 mW laser diode, even when the 5 mW laser diode is operating at a minimum power level, may be high enough that the power consumed by the 5 mW laser diode when the 5 mW diode is operating at threshold current (and providing almost no output) is higher than the power consumed by the 1 mW laser diode when the 1 mW laser diode is operating at its maximum allowable output during continuous operation (i.e. at its stated light output power Po). As such, according to an exemplary embodiment, a 1 mW laser diode and a 5 mW laser diode may each be provided, with the 1 mW laser diode being excited when a lower range is acceptable for the VVSD 10 so as to save power, and the 1 mW laser diode being excited when a longer range is desired for the VVSD 10. The numbers discussed in the above example are of course purely exemplary, and different combinations of two more laser diodes or other lasers may of course be contemplated. Other variants, such as different wavelengths of laser that may be easier to detect under certain environmental conditions and harder to detect under other environmental conditions, may also be contemplated, such as may be desired.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

The following list of claims replaces any prior listing of claims:

1. A visual warning device for a vehicle, comprising:
a housing defining at least one internal cavity, the housing having a front opening;
a plurality of light sources disposed within the at least one internal cavity and configured to face in an outward direction through the front opening, wherein the front opening further comprises a faceplate and a clear lens, the faceplate being tapered such that it conforms to the slope of a windshield, and wherein the faceplate further comprises a soft sidewall creating a seal between the front opening and the windshield;
an electronic control system disposed within the at least one internal cavity and configured to control the plurality of light sources, the electronic control system further having a signal output and a signal input from at least one of the set of:
a vehicular radar system, the vehicular radar system being directed towards a front of the vehicle and including a transmitter and receiver;
a vehicle horn electrical system communicatively coupled to a vehicle horn; and
an emergency flasher electrical system communicatively coupled to a vehicle emergency flasher.

2. The visual warning device of claim 1, wherein the electronic control system has the signal output from the vehicular radar system.

3. The visual warning device of claim 2, wherein the electronic control system further has a signal output from a laser distance measurement system.

4. The visual warning device of claim 2, wherein the vehicular radar system has a 10-degree zone of coverage.

5. The visual warning device of claim 1, wherein the plurality of light sources are light-emitting diodes (LEDs).

6. The visual warning device of claim 1, wherein the plurality of light sources are high-intensity discharge lamps (HIDs).

7. The visual warning device of claim 1, wherein the plurality of light sources provide light at a wavelength between 635 nm and 560 nm.

8. The visual warning device of claim 1, wherein the electronic control system has a connection to a vehicle horn wiring harness, and is configured to receive an electrical signal from the vehicle horn wiring harness and is configured to illuminate the plurality of light sources when an electrical signal is received.

9. The visual warning device of claim 1, wherein the electronic control system has a connection to an emergency flasher, and is configured to receive an electrical signal from the emergency flasher and is configured to illuminate the plurality of light sources when an electrical signal is received.

10. The visual warning device of claim 9, wherein the electronic control system is configured to illuminate the plurality of light sources based on a duty cycle of the emergency flasher.

11. The visual warning device of claim 1, wherein the visual warning device further comprises a curtain, the curtain disposed around the front opening of the housing.

12. The visual warning device of claim 11, wherein the curtain is formed from at least one of rubber or foam.

13. The visual warning device of claim 1, wherein the at least one internal cavity of the housing has a reflective finish.

14. The visual warning device of claim 1, wherein the housing comprises a plurality of internal cavities, wherein the plurality of light sources is disposed within a first internal cavity in the plurality of internal cavities, the first internal cavity having the front opening, and wherein the electronic control system is disposed within a second internal cavity in the plurality of internal cavities.

15. A vehicle having a visual warning device, the visual warning device comprising:
a housing defining at least one internal cavity, the housing having a front opening;
a plurality of light sources disposed within the at least one internal cavity and configured to face in an outward direction through the front opening, wherein the front opening further comprises a faceplate and a clear lens, the faceplate being tapered such that it conforms to the slope of a windshield, and wherein the faceplate further comprises a soft sidewall creating a seal between the front opening and the windshield;
an electronic control system disposed within the at least one internal cavity and configured to control the plurality of light sources, the electronic control system further having a signal output and a signal input from at least one of the set of:
a vehicular radar system, the vehicular radar system being directed towards a front of the vehicle and including a transmitter and receiver;
a vehicle horn electrical system communicatively coupled to a vehicle horn; and
an emergency flasher electrical system communicatively coupled to a vehicle emergency flasher;
wherein the visual warning device is at least one of:
integral with a body of the vehicle; or
disposed on the interior of the vehicle, wherein the front opening of the visual warning device is directed at the windshield of the vehicle.

16. The vehicle of claim 15, wherein the visual warning device further comprises a curtain, the curtain disposed around the front opening of the housing, wherein the curtain is adhered to an internal surface of the windshield of the vehicle.

17. The vehicle of claim 15, wherein the vehicular radar system is integral with the body of the vehicle.

18. The vehicle of claim 15, wherein the electronic control system is enabled based on motion of the vehicle.

19. A method of using a visual warning device of a vehicle, comprising:
detecting, with a vehicular radar system, the vehicular radar system being directed towards a front of the vehicle and including a transmitter and receiver, at least one of a head-on object or a cross-traffic object;
signaling, with an output of the vehicular radar system, an electronic control system, and activating, with the electronic control system, a visual warning device for the vehicle, wherein the visual warning device comprises:
a housing defining at least one internal cavity, the housing having a front opening;
a plurality of light sources disposed within the at least one internal cavity and configured to face in an outward direction through the front opening, wherein the front opening further comprises a faceplate and a clear lens, the faceplate being tapered such that it conforms to the slope of a windshield, and wherein the faceplate further comprises a soft sidewall creating a seal between the front opening and the windshield and in a forward direction with respect to the vehicle; and
the electronic control system, the electronic control system disposed within the at least one internal cavity and configured to control the plurality of light sources.

20. The method of claim 19, wherein the method comprises:
detecting the cross-traffic object, and determining if the cross-traffic object is moving; and
when the cross-traffic object is moving, sending a signal from the vehicular radar system to the electronic control system and activating the visual warning device.
